(19) United States
(12) Patent Application Publication
(10) Pub. No.: US 2003/0169301 A1
(43) Pub. Date: Sep. 11, 2003

(54) Display selection identification enhancement by de-emphasizing non-essential information

(76) Inventors: Stephen G. McCauley, Peoria, AZ (US); James V. Bona III, Phoenix, AZ (US)

Correspondence Address: HONEYWELL INTERNATIONAL INC., 101 COLUMBIA ROAD, P O BOX 2245, MORRISTOWN, NJ, 07962-2245, US

(21) Appl. No.: 10/093,661

(22) Filed: Mar. 7, 2002

(51) Int. Cl. G09G 5/00

(52) U.S. Cl. 345/810

(57) ABSTRACT

Apparatus and method for reducing display clutter and improving the readability of a display by enhancing the display of a selected item or class of items while at the same time de-emphasizing the non-selected items or classes of items. The enhancement of a selected item or class of items may be accomplished in a number of ways, including, but not limited to enhancing the size, color, or other characteristic of the item, including the addition of textual information associated with the selected item. Likewise, the non-selected item(s) may be de-emphasized in a number of ways including, but not limited to decreasing the size thereof, changing the color thereof, increasing the transparency thereof, or otherwise modifying the item to make recognition and use of the selected item easier.

### TECHNICAL FIELD

The present invention relates to a display for a vehicle, and more particularly to a method and apparatus for improving the comprehensibility of such a display where numerous items are being displayed.

### BACKGROUND OF THE INVENTION

Modern map displays, particularly those used in aircraft for flight planning and monitoring, are capable of displaying a considerable amount of information such as flight planning information, flight profile information, airport information, airway information, navigational aid information, other aircraft information, and other information useful to a crew member or air traffic controller in conducting or monitoring a flight.

With certain displays it is possible for a crew member or controller (user) to interact with the display by selecting a particular item of information on the display to have the display system emphasize that item such that the selected item is more readily identified, and subsequently to obtain or quickly recognize pertinent information related to the selected item without undue clutter from other items of information on the display.

Even with displays which emphasize certain information, the amount of information typically displayed, particularly in high density areas, can cause confusion on the part of the user or, at least, increase the workload of the users in discerning pertinent information on the display.

In view of the foregoing, it should be appreciated that it would be desirable to provide methods and apparatus for generating a display which is easy to use and which reduces clutter of useful but not immediately necessary information on the display to thus reduce the workload of the user and to increase the efficiency of the user.

### BRIEF SUMMARY OF THE INVENTION

An apparatus and method are provided for reducing display clutter and improving the readability of a display by enhancing the display of a selected item or class of items while at the same time de-emphasizing the non-selected items or classes of items. The enhancement of a selected item or class of items may be accomplished in a number of ways, including, but not limited to enhancing the size, color, or other characteristic of the item, including the addition of textual information associated with the selected item. Likewise, the non-selected item(s) may be de-emphasized in a number of ways including, but not limited to decreasing the size thereof, changing the color thereof, increasing the transparency thereof, or otherwise modifying the item to make recognition and use of the selected item easier.

### BRIEF DESCRIPTION OF THE DRAWINGS

The present invention will hereinafter be described in conjunction with the appended drawing figures, wherein like numerals denote like elements, and in which:

FIG. 1 is a block diagram of a display system usable with the instant invention;

FIG. 2 is a representation of a display showing a typical mix of information which may appear on a display in an aircraft cockpit;

FIG. 3 is a representation of certain of the information of FIG. 2 showing certain information enhanced and certain other information de-emphasized;

FIG. 4 is a flow chart showing the process of using the display system of FIG. 1 to produce the display characteristics according to the invention.

### DETAILED DESCRIPTION OF A PREFERRED EMBODIMENT

The Present invention may be described in terms of functional block diagrams and various processing steps. It should be appreciated that such functional blocks may be realized in many different forms of hardware, firmware, and/or software components configured to perform the various functions. For example, the present invention may employ various integrated circuit components, e.g., memory elements, digital signal processing elements, look-up tables, and the like, which may carry out a variety of functions under the control of one or more microprocessors or other control devices. Such general techniques are known to those skilled in the art and are not described in detail herein. Moreover, it should be understood that the exemplary process illustrated may include additional or fewer steps or may be performed in the context of a larger processing scheme. Furthermore, the various methods presented in the drawing Figures or the specification are not to be construed as limiting the order in which the individual processing steps may be performed.

It should be appreciated that the particular implementations shown and described herein are illustrative of the invention and its best mode and are not intended to otherwise limit the scope of the invention in any way.

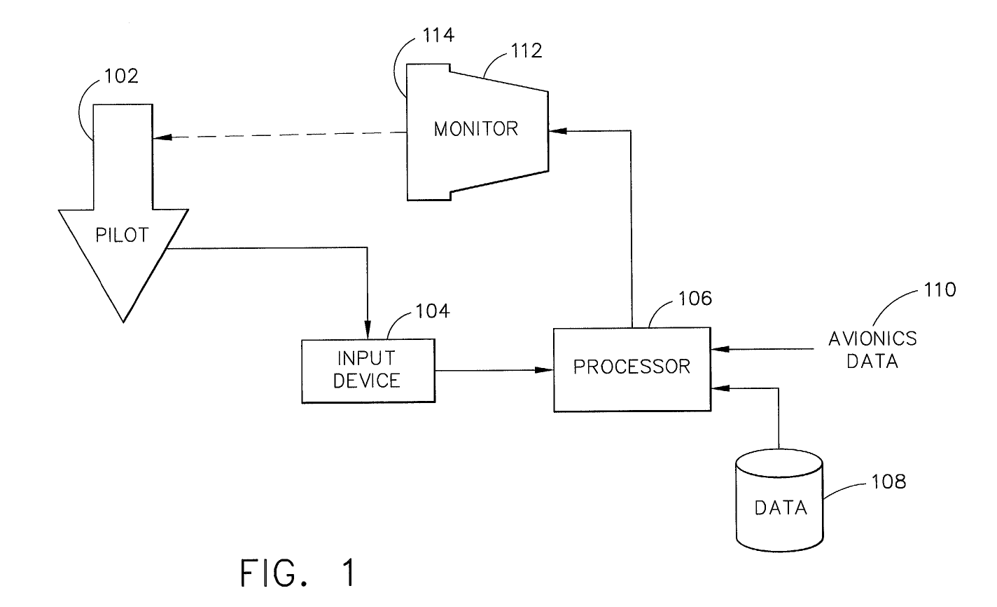

In FIG. 1, an exemplary Multi-function Display System (MFD) 100 includes a processor 106 configured to communicate with an input device 104 through which a pilot or crewmember 102 can provide inputs to the system. The input device may be, for example, a hand input device such as a mouse or a track-ball, a keyboard, or any device which allows a user to point to or select an item on the display. An associated monitor (or monitors) 112, one or more data sources 108, and avionics data 110 are coupled to the processor 106. In general, a user (e.g., a pilot 102) located within a vehicle (e.g., aircraft) (not shown) may provide input to processor 106 through input device 104 and receive visual feedback regarding the status of the aircraft via a display 114 produced by monitor 112. MFD System 100 may be suitably configured for use in a commercial aircraft or any vehicle in which navigational aids, including airways, VHF Omnirange stations (VORs), radio stations or non-directional beacons (NDBs), airports, and/or relative position information is to be displayed. A number of aspects of display element 112 (which are controlled by processor 106 in a practical embodiment) may contribute to the improved contents and appearance of the MFD 114, thus increasing the situational and navigational awareness of the pilot and/or flight crew. The Image generation and display aspects may leverage known techniques such that existing MFD systems can be modified in a straightforward manner to support the different features described herein. In a practical implementation, the concepts described herein may be realized in the form of revised display generation software or processing resident at processor 106.

Processor 106 encompasses one more functional blocks used to provide a flight management, navigational, and positional interface with the pilot, and input to monitor 112. Processor 106 may include or cooperate with a mode, position and/or detection element that is capable of determining the mode or position of the vehicle relative to one or more reference locations, points, planes, or navigation aids. In addition, processor 106 may be configured to receive, analyze, condition, and process navigation and positional information associated with the vehicle. In this regard, processor 106 may include any number of individual microprocessors, flight computers, navigation equipment, memories, storage devices, interface cards, and other standard components known in the art. Moreover, processor 106 may include any number of microprocessor elements, memory elements, power supplies, and other functional components as necessary to support the operation of MFD system 100. In this respect, processor 106 may include or cooperate with any number of software programs or instructions designed to carry out various methods, process tasks, calculations, control functions, and the generation of display signals and other data used by display element 112. For example, processor 106 may be configured to generate an annunciator associated with the position of the aircraft relative to at least one reference location, to generate windows corresponding to user inputs, and the like.

Processor 106 may also be suitable configured to receive and process navigational and/or bearing data 108 related to an intended destination of the aircraft. In a practical commercial aircraft application, such data 108 may be associated with specific waypoints, an airport, navigational aids, or the like. As described in more detail below, processor 106 may process data 108 and generate appropriate signals to display element 112 such that display element 112 generates indicia representative of the appropriate navigational or airport information, or the like. Such processors and flight control computers are available from a number of manufacturers such as Honeywell International Inc. In an exemplary embodiment, processor 106 is incorporated within a flight management system (FMS) or another avionics component which, inter alia, formats navigation data and forwards the data to monitor 112 for display as data on display 114.

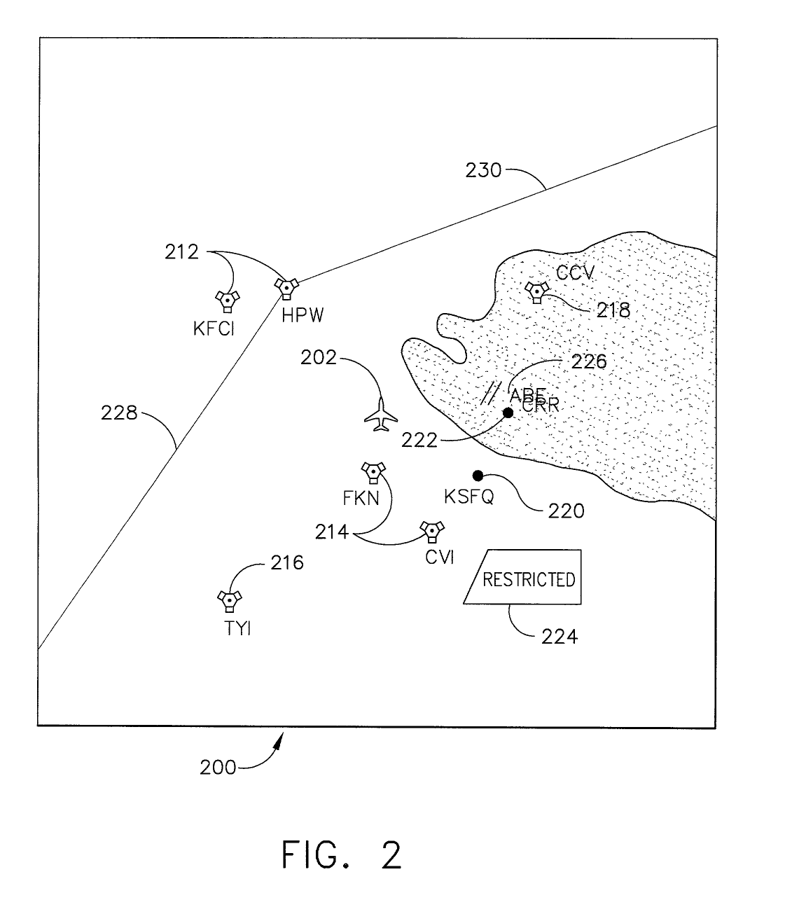

Monitor 112 may include any display monitor suitable for displaying the various symbols and information detailed below. Many currently known monitors are suitable for this task, including various CRT and flat-panel display systems. In an exemplary embodiment, display element 112 includes a multifunction display (MFD) 200, as shown in FIG. 2. Monitor 112 may be based on a panel mounted display, a HUD projection, or any known technology. In an exemplary embodiment, monitor 112 includes a panel display. Display 114 suitably includes various graphical elements associated with the environment of the aircraft including the location of various navigational aids including VHF Omnirange stations, non-directional beacons, radio stations, and the like, and airports, airways, special use airspace, and other aircraft.

FIG. 2 is a representation of a display showing a typical mix of information which may appear on a display in an aircraft cockpit. The present aircraft position 202 is shown to be in the center of the display. Various information regarding navigational, positional, and terrain information is shown of the display as well. Several VORs 212, 214, 216, 218 are shown, as well as certain terrain information 210. Radio stations or NDBs 220, 222 are also depicted, as is a restricted flight area 224. An airport is shown at 226, as are two airways 228, 230.

Associated with each of the above representations is an identifier which may consist of a series of alphanumeric characters which identify the particular navigational aid, airport or other feature. In this view, the identifying information appears as alpha characters of substantially the same size, although a particular display may have certain features shown is other than completely uniform sizes. Each item also would typically have a substantially uniform display brightness and color, although in a particular display, different items or classes of items (e.g., all VORs) could be of different colors or brightness.

As can be seen, in certain particularly crowded portions of the display, the items or their associated alpha characters may appear very close to each other, or even partially superimposed on each other. One such juxtaposition is shown, but in a particularly crowded area, many such interferences may occur. In FIG. 2, the NDB CRR 222 is shown in close proximity to airport ABE 226, and their respective alpha identifiers are partially superimposed on each other.

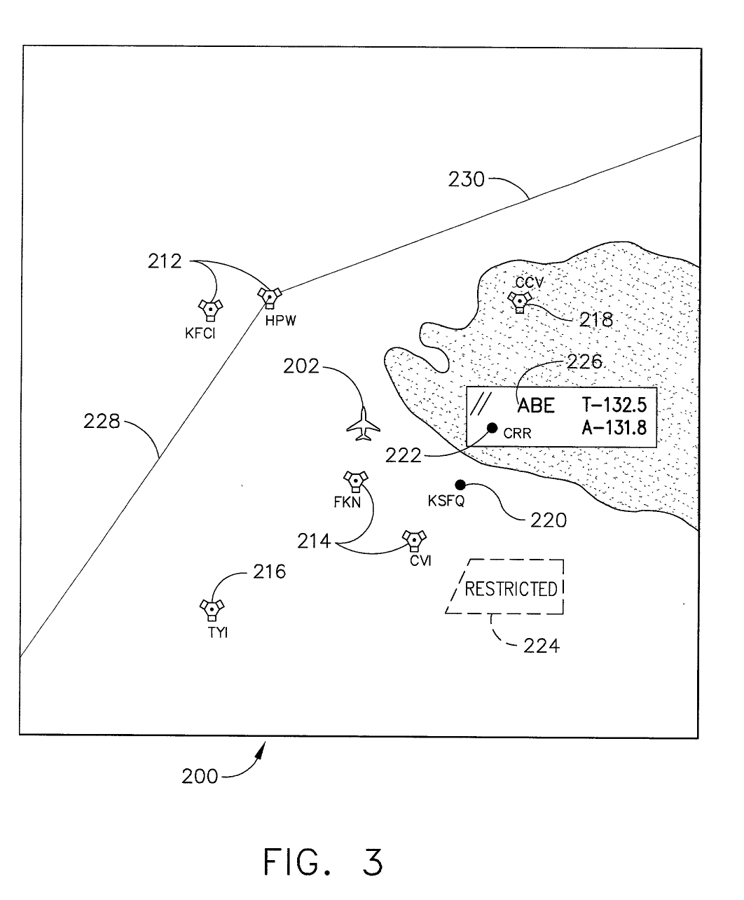

FIG. 3 is a representation of the display of FIG. 2 containing the same information as FIG. 2 (and utilizing the same numerical notations) with certain of the information having been enhanced, and certain of the information de-emphasized in accordance with the invention.

In FIG. 3, for example, the pilot or crew member (user) has selected with a pointing device such as a trackball the airport 226 identified as ABE. As can be seen, the identifier ABE has been enhanced, in this case by increasing its size, while additionally the alpha identifiers for the other items on the screen such as the VORs 212, 214, 216 have been de-emphasized by reducing the identifier in size. In all cases, it is possible to emphasize an item (or class of items, e.g., all VORs) by increasing the brightness of the item(s), by changing the color of the item(s), or by other convenient means of distinguishing the selected item(s). Likewise the de-emphasized items may be de-emphasized by altering the coloration, brightness or relative transparency of the non-selected item(s).

It should be noted that by emphasizing the airport ABE 226 and de-emphasizing the NDB 222, the ABE alpha identifier is much more clearly discernable, thus easing the burden on the user to identify the desired item. As shown in FIG. 3, the ABE identifier in addition to being enlarged (or otherwise emphasized) the identifier appears in a box or a halo to additionally emphasize the identifier.

Also, as shown in FIG. 3, when ABE was selected for enhancement, additional information was provided which did not appear in the original display (FIG. 2). This additional information, in the case of an airport may include such information as frequencies of airport services such as control tower, approach control, or the like. In the case where a VOR is selected, the frequency of the VOR may be displayed in a halo or in association with the emphasized VOR. Similar information could also be displayed for other items. For example, the selection of an airway might result in the display of the VOR frequencies and headings which define the airway.

In the case of the restricted flight area 229, the outline of the area, if unselected, could be rendered more transparent or produced in dashed lines as shown in FIG. 3. Likewise, any other unselected item could be so de-emphasized or diminished.

The present invention may also be used for other display environments. For example, an air traffic control display may use similar techniques for displaying navigational aids and aircraft, such that selection of a particular aircraft would emphasize that aircraft and de-emphasize other aircraft or other items of lesser importance for the operation being performed.

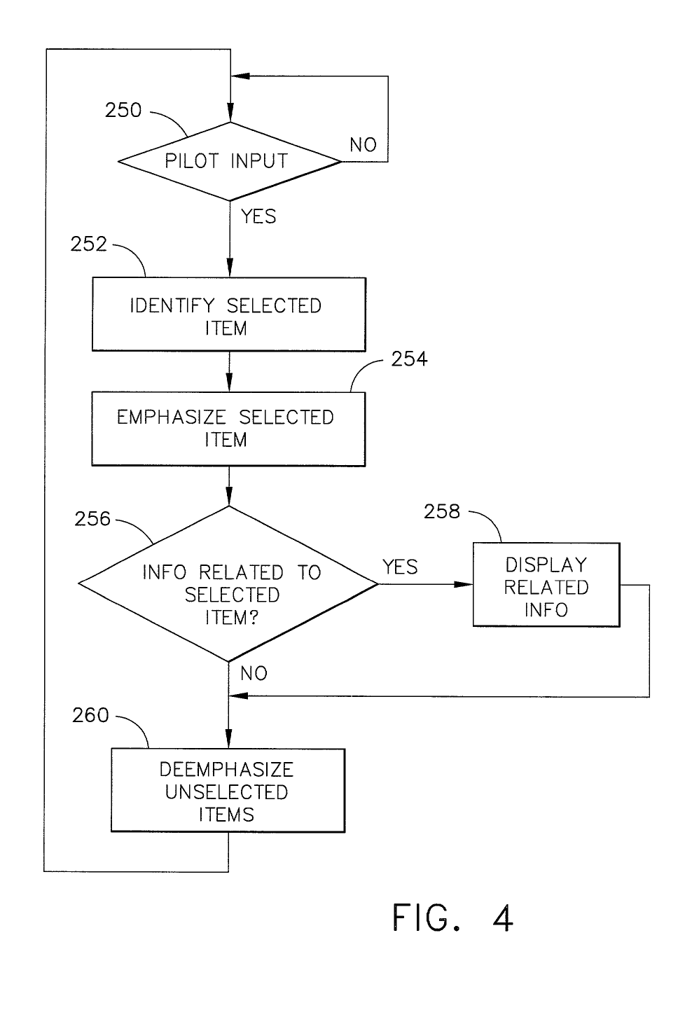

FIG. 4 is a flow chart showing the process of using the display of FIG. 1 to produce the display characteristics according to the invention.

Beginning with decision block 250, the system awaits an input from a user. If there is no input the system idles while waiting, or performs some other function unrelated to that of the invention. Upon receipt of an input identifying a selected item or class of items at 252, the system produces the appropriate signal to the display to provide emphasis of the selected item(s) at 254. It is then determined at 256 whether there is additional information related to the selected item(s), such as the frequency information or other information as described above.

If additional information exists, the information is prepared for display at 258. Following the preparation for display of additional information, if any, or subsequent to the emphasis of the selected item, the unselected items are de-emphasized by providing the necessary display information at 260. The system then returns to block 250 to await the next input.

While the invention has been described in terms related to the preferred embodiment disclosed herein, it will become apparent to those skilled in the art that modifications may be made which however remain within the scope of the appended claims.

What is claimed is:

1. In a system for displaying items of information of one or more classes, having the items displayed as symbols,
selecting one of the items,
upon selection of the item, causing the symbols relating to the selected item to be enhanced while causing the symbols related to the nonselected items to be diminished.

2. A system as set forth in claim 1 wherein the symbols are graphical representations of the items.

3. A system as set forth in claim 1 wherein the symbols are alpha/numeric representations.

4. A system as set forth in claim 1 wherein the symbols are a combination of graphical representations combined with alpha/numeric representations.

5. A system as set forth in claim 1 wherein the item which is caused to be selected is enhanced by varying the coloration of the item.

6. A system as set forth in claim 5 wherein the enhancement is accomplished by altering the brightness of the color of the item caused to be selected.

7. A system as set forth in claim 5 wherein the enhancement is accomplished by causing the item caused to be enhanced to be represented by a different color than the unenhanced item.

8. A system as set forth in claim 1 wherein the item which is caused to be diminished is diminished in coloration.

9. A system as set forth in claim 5 wherein the item which is caused to be diminished is diminished in coloration.

10. A system as set forth in claim 1 wherein the item which is caused to be diminished is diminished by relative transparency.

11. A system as set forth in claim 1 wherein the item which is caused to be enhanced is enhanced by increasing the size of the item.

12. A system as set forth in claim 1 wherein the item caused to be diminished is diminished by reducing the size of the item.

13. A system as set forth in claim 1 wherein the item which is caused to be diminished is diminished by reducing the size of the item.

14. In a system for displaying items of information of a plurality of classes, having the items displayed as symbols,
selecting one of the items,
upon selection of the item, causing the symbols relating to the items in the class of the selected item to be enhanced while causing the items in classes other than the class of the selected item to be diminished.

15. A system as set forth in claim 14 wherein the symbols are graphical representations of the items.

16. A system as set forth in claim 14 wherein the symbols are alpha/numeric representations.

17. A system as set forth in claim 14 wherein the symbols are a combination of graphical representations combined with alpha/numeric representations.

18. A system as set forth in claim 13 wherein the items in the same class as the item which is caused to be selected is enhanced by varying the coloration of the item.

19. A system as set forth in claim 18 wherein the enhancement is accomplished by altering the brightness of the color of the item in the same class as the item caused to be selected.

20. A system as set forth in claim 18 wherein the enhancement is accomplished by causing the items in the same class as the item caused to be enhanced to be represented by a different color than the items in the other classes.

21. A system as set forth in claim 13 wherein the items which are caused to be diminished are diminished in coloration.

22. A system as set forth in claim 13 wherein the items which are caused to be diminished are diminished in coloration.

23. A system as set forth in claim 13 wherein the items in the class of the item which was caused to be enhanced are enhanced by increasing the size of the items in the class of the item caused to be enhanced.

24. A system as set forth in claim 13 wherein the items caused to be diminished are diminished by reducing the size of the items.

25. A system as set forth in claim 23 wherein the items which are caused to be diminished are diminished by reducing the size of the items.

26. In a system for displaying items of information of one or more classes, having the items displayed as symbols,
selecting one of the items,
upon selection of the item, causing the symbols relating to the selected item to provide additional information related to the item while causing the symbols related to the nonselected items to be diminished.

27. A system as set forth in claim 26 wherein the selected item represents a navigational aid and the additional information represents the frequency of the navigational aid.

28. A system as set forth in claim 26 wherein the selected item represents an airport and the additional information represents frequencies in use at the selected airport.

29. A system as set forth in claim 26 wherein the selected item represents an airway and the additional information represents headings and navigational aids related to the airway.

30. A system as set forth in claim 26 wherein the selected item represents an airway intersection and the additional information represents headings and navigational aids related to the intersection.

31. A system as set forth in claim 26 wherein the selected item represents an aircraft and the additional information represents data regarding the aircraft.

32. A system as set forth in claim 31 wherein the data is altitude data.

33. A system as set forth in claim 26 wherein the data represents an item of aeronautical information and wherein the additional information represents relevant information with respect to the aeronautical information.
